(19) United States
(12) Patent Application Publication
(10) Pub. No.: US 2017/0370347 A1
(43) Pub. Date: Dec. 28, 2017

(54) PORTABLE WIND TURBINE

(71) Applicant: Daniel E. DAVIS, San Benito, TX (US)

(72) Inventor: Daniel E. DAVIS, San Benito, TX (US)

(21) Appl. No.: 15/633,484

(22) Filed: Jun. 26, 2017

Related U.S. Application Data
(60) Provisional application No. 62/355,220, filed on Jun. 27, 2016.

(51) Int. Cl. F03D 13/40; B65D 88/12; E04H 12/20; F03D 13/20; B65D 85/68; E04H 12/22

(52) U.S. Cl. CPC F03D 13/40; B65D 85/68; E04H 12/2246; E04H 12/20; F03D 13/20; B65D 88/123; F05B 2240/94; B65D 2585/6877

(57) ABSTRACT

A portable wind turbine is adjustable between an operating configuration and a stowed configuration. The portable wind turbine comprises a turbine tower and a base. The base includes a floor and a pair of opposing sidewalls. The base includes four lower corners. The base is configured to store the turbine tower when the portable wind turbine is in the stowed configuration. The turbine tower is oriented in an upright manner such that the turbine tower projects upwardly away from the floor of the base when the portable wind turbine is in the operating configuration. An outrigger is attached at each of the four lower corners of the base when the portable wind turbine is in the operating configuration.

### BACKGROUND OF THE DISCLOSURE

### Field of the Disclosure

Embodiments of the present disclosure generally relate to a portable wind turbine.

### Description of the Related Art

One problem with a portable wind turbine is an inherent instability that results from the moment associated with an upright turbine tower and a nacelle/hub connected thereto. Because a base of the portable wind turbine is not anchored to the ground in a permanent or semi-permanent fashion, the moment that will destabilize the portable wind turbine is reduced. Consequently, the height of a turbine tower is limited for a portable wind turbine. Moreover, a generator capacity of the portable wind tower is limited because an increased generator capacity typically coincides with an increased weight associated with the nacelle/hub.

### SUMMARY OF THE DISCLOSURE

Embodiments of the present disclosure generally relate to a portable wind turbine. In one embodiment, a portable wind turbine adjustable between an operating configuration and a stowed configuration comprises: a turbine tower; and a base, the base including a floor and a pair of opposing sidewalls, the base including four lower corners, the base configured to store the turbine tower when the portable wind turbine is in the stowed configuration, the turbine tower being oriented in an upright manner such that the turbine tower projects upwardly from the floor of the base when the portable wind turbine is in the operating configuration, an outrigger being attached adjacent each of the four lower corners of the base when the portable wind turbine is in the operating configuration.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates a perspective view of an embodiment of a base of a portable wind turbine in accordance with the disclosure, the base being a flat-rack container.

FIG. 2 illustrates a left side view of an embodiment of a portable wind turbine in an operating configuration, the base being the flat-rack container shown in FIG. 1. The right side view of the portable wind turbine is essentially a mirror image of the left side view.

FIG. 3 illustrates a left side view of an embodiment of the portable wind turbine shown in FIG. 2 in a stowed configuration.

### DETAILED DESCRIPTION

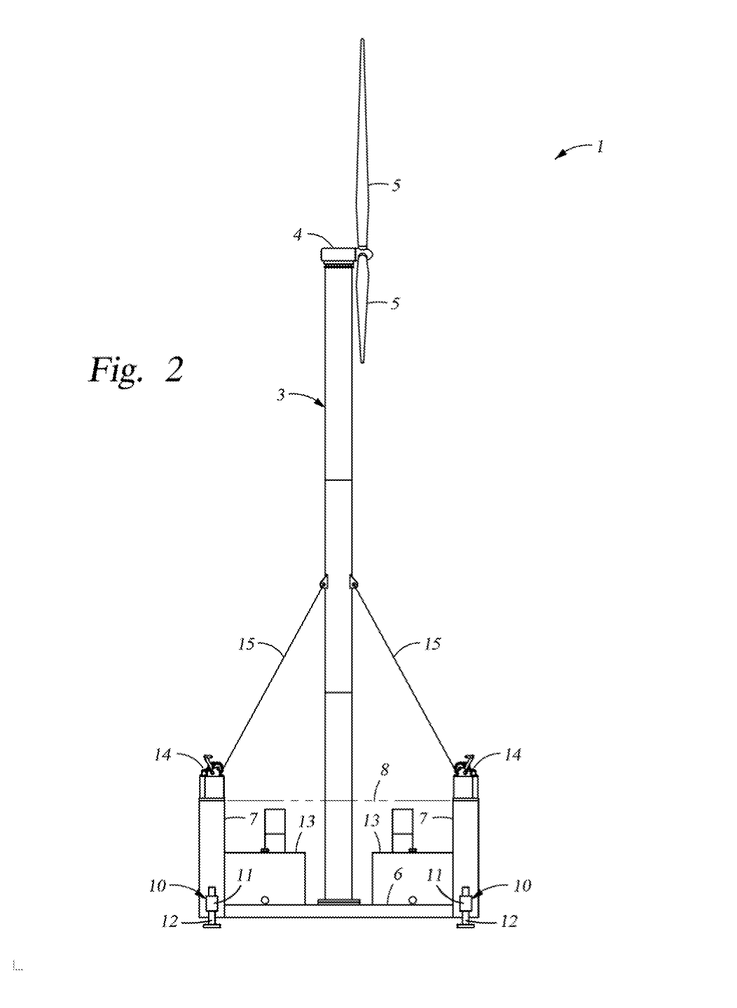

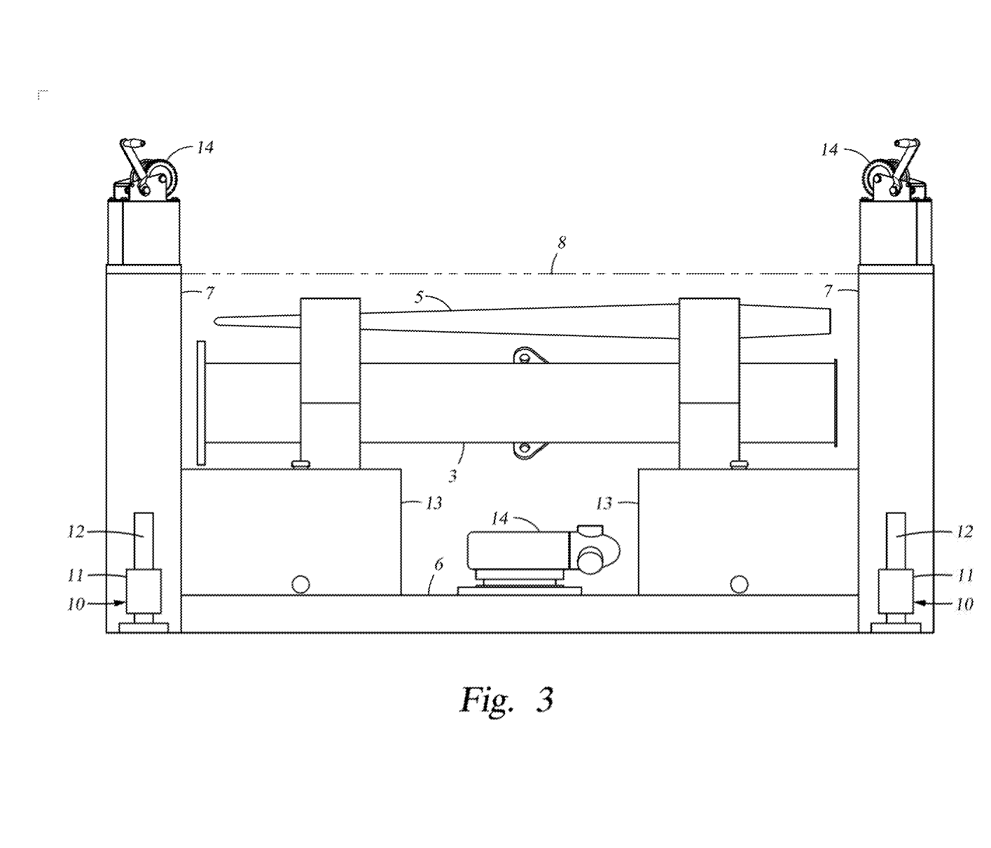

The present disclosure relates to a portable wind turbine 1 and methods of assembling the portable wind turbine. The portable wind turbine 1 may include a base 2, a turbine tower 3, a nacelle/hub 4, and a plurality of blades 5 (e.g., three blades). The portable wind turbine 1 is capable of adjusting between an operating configuration illustrated in FIG. 2 and a stowed configuration illustrated in FIG. 3. When the portable wind turbine 1 is in the operating configuration illustrated in FIG. 2, the turbine tower 3 is oriented in an upright manner, the nacelle/hub 4 attached to a top of the turbine tower, and the plurality of blades 5 attached to the nacelle/hub. The portable wind turbine 1 is thus oriented in a manner such that it can generate electricity. When the portable wind turbine is in the stowed configuration illustrated in FIG. 3, the turbine tower 3, the nacelle/hub 4, and the plurality of blades 5 are stored by the base 2. The base 2 is adapted such that when the portable wind turbine 1 is in the stowed configuration, the base 2 can be towed by a vehicle from one location to another location. To facilitate towing the portable wind turbine 1 when it is in the stowed configuration, the base 2 may include wheels (not shown) and/or a hitch (not shown). It should be understood, however, that other methods of towing the base 2 may be employed that do not require wheels and/or a hitch.

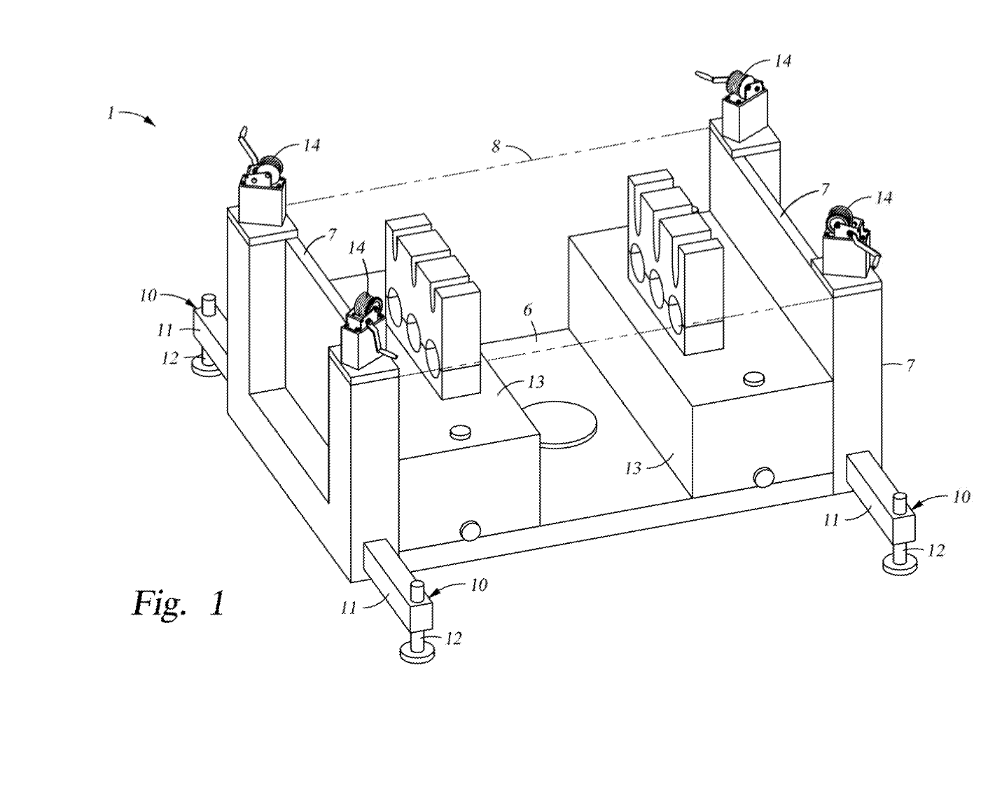

The base 2 may include a floor 6 and a pair of opposing sidewalls 7. In such an embodiment, the base 2 may be a flatrack shipping container. The base 2 may include four lower corners. In FIGS. 1-3, the four lower corners of the base 2 are defined by the edges of the rectangular floor 6. As illustrated in FIG. 2, when the portable wind turbine is in the operating configuration, outriggers 10 may be attached to the base 2. More specifically, outriggers 10 may be attached to the base 2 adjacent each of the four lower corners of the base. Although outriggers 10 are shown as being attached to the base 2 adjacent each of the four lower corners of the base at right angles, it should be understand that the orientation of the outriggers 10 could be adjusted without departing from the scope of the present disclosure. Depending upon the arrangement of the floor 6 and the pair of opposing sidewalls 7, the outriggers may be attached to the floor, the sidewalls, or the floor and sidewalls. For example, in FIGS. 1-2, the pair of opposing sidewalls 7 rest on a top surface of the floor 6 and the outriggers 10 attach to the floor only. It is to be understood that the outriggers 10 may attach to the floor 6 in any manner known to a person of ordinary skill in the art.

The outriggers 10 may include a horizontal portion 11 extending away from the base 8 and a vertical portion 12 extending downward to a ground surface. When the portable wind turbine 1 is in the operating configuration, a bottom surface of the vertical portion 12 of each outrigger 10 may be the only portion of the portable wind turbine contacting the ground surface. As such, the vertical portion 12 must be sized appropriately to ensure the vertical portion of the outriggers 10 can withstand the entire weight of the portable wind turbine. In an alternative embodiment, however, the outriggers 10 may include only a horizontal portion 11. In such an embodiment, when the portable wind turbine 1 is in the operating configuration, a bottom surface of the base 2 as well as a bottom surface of the horizontal portion 11 of each outrigger 10 may be contacting the ground surface, thereby increasing the amount of surface area contacting the ground surface. The outriggers 10 provide stability to the portable wind turbine 1 when the wind turbine is in the operating configuration by increasing the footing area of the base 2. By increasing the footing area of the base 2, the moment required to destabilize the portable wind turbine 1 is increased. Consequently, the height of the turbine tower 3 and/or the generator capacity of the nacelle/hub 4 can be increased without destabilizing the portable wind turbine 1.

The floor 6 and the pair of opposing sidewalls 7 may collectively define a base boundary 8. Upper edges of the base boundary 8 are illustrated by dashed lines in FIGS. 1-3. In FIGS. 1-3, the base boundary is a cuboid. More specifically, in FIGS. 1-3, the base boundary is a rectangular cuboid. As such, the base boundary 8 has four lower corners and four upper corners.

Additionally, the base 2 may include containers 13 adapted to hold liquid. As shown in FIGS. 2 and 3, the containers 13 may be located within the base boundary 8. When the portable wind turbine 1 is in the operating configuration as illustrated in FIG. 2, the containers 13 may be filled with liquid (e.g., water) to increase a weight of the base 2. Depending upon the size of the portable wind turbine 1, only one container 13 may be located within the base boundary 8 and filled with liquid. Alternatively, two or more containers 13 may be located within the base boundary 8 and filled with liquid. By filling the containers 13 with liquid, the weight of the base 2 is increased to further stabilize the portable wind turbine 1 when it is in the operating configuration. By increasing the weight of the base 2, the height of the turbine tower 3 and/or the generator capacity of the nacelle/hub 4 may be able to be further increased without destabilizing the portable wind turbine 1.

Winches 14 may be attached to the base 2 and located at each of the four upper corners of the base boundary 8. More specifically, the winches 14 may be positioned on a top surface of the sidewalls 7 at each of the four corners of the base boundary 8. When the portable wind turbine 1 is in the operating configuration, each winch 14 may be operatively connected to the turbine tower 3 by a cable 15 to further increase the stability of the portable wind turbine 1. By operatively connecting the turbine tower 2 to the winches 14 via the cable 15, the height of the turbine tower 3 and/or the generator capacity of the nacelle/hub 4 may be able to be further increased without destabilizing the portable wind turbine 1.

FIG. 3 illustrates the portable wind tower 1 in the stowed configuration. When the portable wind turbine 1 is placed in the stowed configuration, liquid within the containers 13 may be emptied to decrease the weight of the base 2. By emptying the liquid that was in the containers 13 when the portable wind tower 1 was in the operating configuration, a vehicle that is being used to tow the portable wind turbine from one location to another location will not have to haul the weight of the liquid. Consequently, the containers 13 enable a user to selectively increase the weight of the base 2 depending upon whether the portable wind turbine 1 is in the stowed configuration or the operating configuration.

Moreover, when the portable wind turbine 1 is in the stowed configuration, the turbine tower 3, the nacelle/hub 4, and the plurality of blades 5 may be stowed within the base boundary 8 of the base 2. When in the stowed configuration, the blades 5 may be detached from the nacelle/hub 4. Although the plurality of blades 5, the nacelle/hub 4, and the containers 13 are illustrated in FIG. 3 as being stored within the base boundary 8 of the base 2 when the portable turbine tower 1 is in the stowed configuration, it is to be understood that in some situations, the plurality of blades 5, the nacelle/hub 4, and/or the containers 13 may be removed from the base. By removing the plurality of blades 5, the nacelle/hub 4, and/or the containers 13 from the base 2, an amount of space available for storing the turbine tower 2 within the base boundary 8 is increased. Depending upon the situation, this may be necessary to enable the turbine tower 2 to have a greater height when the portable wind turbine 1 is in the operating configuration yet still be able to be stored within the base boundary 8 of the base 2 when the portable wind turbine is in the stowed configuration.

When the portable wind turbine 1 is in the stowed configuration, outriggers 10 may be detached from the base 2. In some situations, the outriggers 10 may be stored within the base boundary 8 of the base 2. Alternatively, the outriggers 10 may be stored on an outer surface of the base 2. As yet another alternative, the outriggers 10 may be stored in a location separate from the base 2. As illustrated in FIG. 3, when the portable wind turbine 1 is in the stowed configuration, the bottom surface of the floor 6 is resting on a ground surface. As previously discussed, wheels (not shown) may be attached to the base 2 to facilitate towing of the portable wind turbine 1 from one location to another location.

The portable wind turbine 1 may also include a drive motor (not shown) and a programmable logic controller (PLC, not shown) that enables the portable wind turbine to automatically adjust between the stowed configuration and the operating configuration. In such a situation, turbine tower 3, nacelle/hub 4, and/or blades 5 may be stored within base boundary 8 in a manner such that they are connected to each other. Upon operation of the drive motor, the turbine tower 3, nacelle/hub 4, and/or blades 5 may self-assemble so as to enable the portable wind turbine 1 to automatically adjust between the stowed configuration and the operating configuration. Moreover, outriggers 10 may be telescoping outriggers comprising a plurality of cylinders capable of being received within each other. In such a situation, the telescoping outriggers may be stored within the base 2. More specifically, the telescoping outriggers may be stored within floor 6 or sidewalls 7 (depending upon the orientation and arrangement of the floor relative to the sidewalls). The telescoping outriggers may also be connected to the drive motor such that upon operation of the drive motor, the telescoping outriggers will automatically adjust between a retracted configuration and an expanded configuration. It is to be understood that the telescoping outriggers could be connected to a drive motor separate from the drive motor used to adjust the portable wind turbine 1 between the stowed configuration and the operating configuration. By utilizing drive motor(s) to automatically adjust the portable wind turbine 1 between the stowed configuration and the operating configuration and to adjust the telescoping outriggers between a retracted configuration and an expanded configuration, the need for a crane at a remote location where the portable wind turbine 1 is being utilized may be eliminated. Alternatively, the load capacity of a crane needed at the remote location may be reduced.

In an alternative embodiment, the base 2 may also include a second pair of opposing sidewalls (not shown). In such an alternative embodiment, the base 2 may be an open-top shipping container. The other elements of base 2 are substantially identical to those described in the above embodiment and will therefore not be discussed in further detail again.

While the foregoing is directed to embodiments of the present disclosure, other and further embodiments of the disclosure may be devised without departing from the basic scope thereof, and the scope thereof is determined by the claims that follow.

1. A portable wind turbine adjustable between an operating configuration and a stowed configuration, the portable wind turbine comprising:
a turbine tower; and
a base, the base including a floor and a pair of opposing sidewalls, the base including four lower corners, the base configured to store the turbine tower when the portable wind turbine is in the stowed configuration, the turbine tower being oriented in an upright manner such that the turbine tower projects upwardly from the floor of the base when the portable wind turbine is in the operating configuration, an outrigger being attached adjacent each of the four lower corners of the base when the portable wind turbine is in the operating configuration.

2. The portable wind turbine of claim 1 wherein the floor and the pair of opposing sidewalls collectively define a base boundary, the turbine tower being stored within the base boundary when the portable wind turbine is in the stowed configuration.

3. The portable wind turbine of claim 2 wherein the base boundary is a cuboid.

4. The portable wind turbine of claim 3 wherein the base boundary is a rectangular cuboid.

5. The portable wind turbine of claim 1 wherein the base is adapted to be towed by a vehicle from one location to another location when the portable wind turbine is in the stowed configuration.

6. The portable wind turbine of claim 1 wherein the base further includes at least one container located within the base boundary, the at least one container being adapted to hold liquid, liquid being within the at least one container when the portable wind turbine is in the operating configuration.

7. The portable wind turbine of claim 6 wherein the at least one container is empty when the portable wind turbine is in the stowed configuration.

8. The portable wind turbine of claim 1 wherein the base of the portable wind turbine is a flatrack shipping container.

9. The portable wind turbine of claim 2 wherein the pair of opposing sidewalls is a first pair of opposing sidewalls and the base includes a second pair of opposing sidewalls, the first and second pairs of opposing sidewalls and the floor collectively defining the base boundary.

10. The portable wind turbine of claim 1 wherein the base of the portable wind turbine is an open-top shipping container.

11. The portable wind turbine of claim 9 wherein the base boundary includes four upper corners, a winch being attached to the base at each of the four upper corners of the base boundary, each winch being operatively connected to the turbine tower by a cable when the portable wind turbine is in the operating configuration.

12. The portable wind turbine of claim 11 wherein the cable is steel.
